(19) United States
(12) Patent Application Publication
(10) Pub. No.: US 2016/0141874 A1
(43) Pub. Date: May 19, 2016

(54) Charging Electronic Devices

(71) Applicant: ChargeSync Limited, London (GB)

(72) Inventors: Matthew Hunt, Middlesex (GB); Harry Breach, London (GB)

(21) Appl. No.: 14/899,590

(22) PCT Filed: Jun. 5, 2014
(86) PCT No.: PCT/GB2014/051747

§ 371 Date: Dec. 18, 2015

(30) Foreign Application Priority Data
Jun. 19, 2013 (GB) 1310939.2

(51) Int. Cl. H02J 3/14; G05B 15/02; H02J 7/00

(52) U.S. Cl. CPC H02J 3/14; H02J 7/0013; G05B 15/02

(57) ABSTRACT

A device and method are presented by which a client device can be charged according to a charging scheme which takes accounted of predicted energy cost over a charging interval and the predicted discharge rate of the client device in that time. Multiple client devices can be controlled to optimise the times at which they are charged from the power network in order to minimise energy costs.

### FIELD

The present disclosure relates to control of the charging of electronic devices. In particular, but not exclusively, the present disclosure relates to the management of load on a power grid while charging multiple electronic devices.

### BACKGROUND

The load on an electrical power grid is variable. It depends upon the requirements of the users of the grid. Some variations are relatively predictable, such as a greater use of energy during the daytime as compared to the night, or increased demand for electric lighting during winter evenings as compared to the same times during summer. However, other variations are unpredictable since they arise from individual choices that cannot be understood in advance.

Large scale storage of excess electrical energy is inefficient and/or expensive. As a result, while some infrastructure investments have been proposed and made to store excess energy created while demand is low (typically by converting electrical energy to some other form), the primary mechanism for managing variations in demand is to create a corresponding variation in power supply. Despite efforts over many years to improve the responsiveness of the grid supply to demand, this process remains imperfect, inefficient and expensive.

Indeed, recent trends suggest that modifying the generation of electricity to satisfy variations in demand is likely to become more difficult in future. In particular, while it may be possible to control the power output of conventional generators by controlling the fuel supply (such as gas or coal) this is not appropriate for certain renewable energy sources which rely on climatic conditions, such as wind or solar power. While it may be possible to turn off renewable sources in times of low demand (although this is not always trivial—wind turbines for example are often not designed to operate without a load) there is no option to increase generation in times of high demand or even meet stable demand when conditions are not optimum. If, for example, the sun is not shining or the wind is not blowing these energy sources cannot operate. Conversely, while climatic conditions are favourable, it is wasteful not to generate the maximum energy simply because current demand is low.

The unpredictability of the supply is further exacerbated by the movement towards micro-generation, with customers able to “feed-in” locally generated energy to the grid. While this offers potential environmental benefits, it contributes further to a situation in which it becomes increasingly difficult to match supply to demand. In essence, while demand has always been considered unpredictable, conventional power sources at least offered predictability to the supply. Increasingly both demand and supply of electrical power/energy are unpredictable, making it increasingly difficult to avoid inefficiency and energy loss.

If supply is difficult to control and large scale storage is dismissed as too expensive and/or inefficient then focus returns to the demand side, which has conventionally been allowed to fluctuate. Indeed, proposals have been made that are designed to mitigate variations in demand. For example, differential price tariffs have been proposed as a method of encouraging users to defer demand to less demand intensive times. For instance, energy usage may be cheaper at night. However, while this approach may assist in smoothing out predictable variations in demand or supply, they do not address unpredictable fluctuations in demand or supply unless tariffs vary and users can respond in real time.

In summary, there is a continuing and increasing need to improve the management of demand within power networks, particularly electricity grids.

### SUMMARY

According to a first aspect of the present disclosure, there is provided a method for managing demand within a power network, comprising
obtaining status information regarding a plurality of client devices, the status information including information defining for each client device a charging interval and information defining a discharge rate for each client device during the charging interval;
obtaining grid information regarding a power network, the grid information defining predicted energy costs for a plurality of charging periods within the charging interval;
deriving, based on the status information and the grid information, a charging scheme for each client device to be applied during the charging interval, wherein the charging scheme comprises instructions regarding times during the charging interval the client device should and should not charge; and
transmitting instructions to the client devices in accordance with the charging scheme during the charging interval.

Advantageously, the method may be used to reduce the variation in the load on a power network by assessing the needs of client devices connected to that network. Status information regarding the client devices may be aggregated and a charging scheme developed for a forthcoming charging interval. Charging intervals may vary for each client device. The client devices may then be instructed to charge or not to charge accordingly. These instructions may be explicit, specifying particular times at which charging should occur, or implicit, establishing conditions under which charging should occur. Furthermore, the instructions may be directly communicated (for example, by a point-to-point message) or may be indirectly communicated (such as via a mesh network, for example). By aggregating information relating to multiple client devices and to the power supply network, an optimisation strategy can take account of the overall requirements of the system. The system may take advantage of the improving capabilities of local energy storage (such as batteries) to provide a distributed approach to managing the relationship between supply and demand in a network.

The charging scheme may ensure that the charge state of the client device remains within a predetermined range. For example, the charging scheme may take account of the charging rate and the discharge rate of the client device to ensure that it remains at all times within a predetermined range.

In some preferred embodiments, the charging scheme may further comprise instructions regarding times during the charging interval the client device should and should not discharge. For example, the client device may be used as a power supply to supplement power available from the power network. The client device may charge from the power network at times of relatively low cost and discharge to provide power to connected devices or appliances when energy on the power network is relatively expensive.

Deriving the charging scheme may comprise calculating, selecting, looking up (from a look up table, for example), evaluating a function or in any other way establishing the charging scheme. The charging scheme for each client device may depend upon the status information for that device, but may advantageously depend on status information for multiple or all client devices. Such an approach may assist in ensuring that the charging scheme for each client device takes account of the overall needs of the system. The charging scheme for a client device may comprise a schedule for charging the client device. That is to say, a charging scheme may comprise instructions regarding times during the charging interval the client device should charge and times during which it should not charge.

The status information may be independently established or may be received from the client device. For example, the status information may be received from the client device over a network, such as the internet. The status information may comprise user preference information. User preference information may, for example, set the start and/or end points of the charging interval. The user preferences may define a desired outcome at the end of the charging interval. For example, a user may set a preference that the charging interval will end at 9 am in the morning by which time they wish the device to be fully charged.

Status information may comprise information relating to the current charge state of the device. Additionally or alternatively, the status information may also comprise further details relating to the device, such as a charge rate (indicating the rate at which the device charges), a discharge rate (indicating the rate at which charge is discharged from the device) and/or charge capacity (indicating the maximum charge for the device). Furthermore, the status information may comprise detailed information relating to potential discharge rates for the device in different modes of operation. The status information may therefore enable the method to calculate a length of time the device may operate on battery power or any other local energy storage means (wired or wirelessly connected) and/or a length of time required to charge the device to a required charge state.

The charging interval may be a period of time during which the control of the charging of a client device has been ceded to the system. The charging interval may represent a time during which the client device is expected to be available for charging. For example, the end of a charging interval may coincide with a time at which it is expected that a portable client device will be disconnected from the network. However, in some cases the client device may be permanently or semi-permanently connected to the network, and the charging interval may not be associated with expected disconnection. The charging interval may begin immediately when status information is sent from the device, or may begin at some time in the future. The charging interval may typically comprise a defined end point. As such, the charging scheme can be calculated so as to achieve a desired outcome at the end of the charging interval.

Optionally, the status information comprises location information for the client device, and the charging scheme may depend upon the location information. In this manner, load on the power network can be managed geographically and may avoid, for example, excessive demand at one geographic point while there is minimal demand elsewhere.

This may, for example, help to avoid or minimise transmission losses that may be incurred when power is transferred from one geographic location to another.

In some embodiments, the charging scheme is effective to defer charging of at least one of the client devices. By deferring charging of at least one of the client devices, demand on the power network can be managed over the charging interval. The deferral of charging thereby creates advantages over the interval even if in the short term a device is obliged to operate from an internal power source. For example, a user may be incentivised to allow this to happen by receiving payments in line with the flexibility the user is prepared to offer (e.g. in line with the length of the charging interval).

Optionally, the charging scheme is calculated to minimise cost incurred during the charging interval. The cost may be incurred by the user of the client device in payment for power drawn from the power network. For example, the cost of power may vary during the charging interval, meaning that it is cheaper to charge a device at certain times within the interval than at other times. The cost of power may vary according the relationship between supply and demand in the system, or may vary for another reason. To assist with the process of minimising cost, the grid information may comprise predicted energy cost in the power network during the charging interval. The grid information may further comprise additional or alternative details, such as predicted supply and/or demand during the charging interval. The grid information may also comprise details or predictions of the nature of the supply, such as energy sources providing supply during the charging interval.

The charging interval may be sub-divided into a plurality of charging periods. This may take advantage of the fact that in many conventional power networks a pricing structure is developed based on a sequence of price periods. For example, during a first price period the cost of power may be x, while in a subsequent price period the cost may be y. The charging periods of the charging interval may be aligned with price periods of the charging network. The charging scheme may comprise instructions for client devices to charge from the power network during a subset of the charging periods contained within the charging interval. For example, charging may be instructed only when the price is relatively low.

In some embodiments, the method further comprises periodically updating the charging scheme. Optionally, the charging scheme is updated at the end of each charging period.

In this manner, the charging scheme can adapt to changes in circumstances or fresh information regarding either the power network or the client devices.

Optionally, the method further comprises the step of receiving usage information from the client devices regarding power used by each client device during the charging interval. In this manner, demonstrable information showing the effectiveness of the method can be obtained, providing confidence that demand has been successfully managed.

According to a second aspect of the present disclosure, there is provided a system for managing demand, comprising
a power network;
a communications network;
a plurality of client devices connected to both the power network and the communications network; and
a demand management server for receiving status information regarding the client devices and grid information regarding the power network, the status information including information defining for each client device a charging interval and information defining a discharge rate for each client device during the charging interval and the grid information defining predicted energy costs for a plurality of charging periods within the charging interval, wherein
the demand management server is arranged to determine a charging scheme for each client device to be applied during the charging interval using the status information and the grid information wherein the charging scheme comprises instructions regarding times during the charging interval the client device should and should not charge, and the demand management server is arranged to transmit instructions to the client device in accordance with the charging scheme during the charging interval.

The second aspect provides a system particularly suited to implementation of methods such as that of the first aspect. Preferred features of the first aspect may be applied equally to the second aspect.

According to a third aspect of the present disclosure, there is provided a method for managing demand within a power network, comprising
aggregating charging control of a plurality of client devices associated with a plurality of users;
managing charging of the plurality of client devices from a power network at a demand management server,
obtaining data regarding power usage by client devices from the power network;
providing data regarding power usage to an entity associated with the power network.

By aggregating control of the charging of a plurality of client devices, and obtaining data about the power usage by those devices, this aspect allows useful data to be offered to entities associated with a power network. The entity may be a power provider or another operator of the network, or may be, for example, the grid. The entity may also be an agent or associate of such participants. Aggregating control of a plurality of client devices in this aspect comprises a single entity assuming control for multiple devices which previously were independently controlled. The data that may be provided in this manner may allow a power provider to optimise systems and reduce inefficiency. There is an economic benefit associated with such advantages which can enable the provision of incentives to the users of the client devices. For example, financial incentives can be provided in terms of reduced energy bills or in some other manner (such as entry to a lottery or other competition). Optional features of the first and second aspects of the disclosure may also be applied to third aspect.

Aspects of the present disclosure are also manifest at the device side of the system. For example, according to a fourth aspect there is provided a method for controlling charging of a device, comprising transmitting status information to a demand management server, the status information including information defining a charging interval; receiving instructions from the demand management server reflecting a charging scheme to be applied during the charging interval; and charging the device in accordance with the received instructions during the charging interval. Furthermore, according to a fifth aspect, there is provided a device comprising a processor configured to: transmit status information to a demand management server, the status information including information defining a charging interval; receive instructions from the demand management server reflecting a charging scheme to be applied during the charging interval; and cause charging of the device in accordance with the received instructions. The device of the fourth or fifth aspect may be charged from a power network such as an electricity grid. Optional features of the first aspect may equally be applied to the fourth and fifth aspects.

It can also be appreciated that aspects of the disclosure can be implemented using computer program code. Indeed, according to a further aspect of the present disclosure, there is therefore provided a computer program product comprising computer executable instructions for carrying out the method of the first aspect. In a yet further aspect of the present disclosure, there is provided a computer program product comprising computer executable instructions for carrying out the method of the third aspect. In a still yet further aspect of the present disclosure, there is provided a computer program product comprising computer executable instructions for carrying out the method of the fifth aspect. The computer program product may be a physical/tangible storage medium. For example, the storage medium may be a Read Only Memory (ROM) or other memory chip. Alternatively, it may be a disk such as a Digital Versatile Disk (DVD-ROM) or Compact Disk (CD-ROM) or other data carrier. It could also be a signal such as an electronic signal over wires, an optical signal or a radio signal such as to a satellite or the like. The disclosure also extends to a processor running the software or code, e.g. a computer configured to carry out the method described above.

### BRIEF DESCRIPTION OF THE DRAWINGS

Specific embodiments will now be described with reference to the accompanying drawings, in which:

FIG. 1 illustrates a system architecture for implementing an embodiment;

FIG. 2 is a flow diagram illustrating the operation of the embodiment;

FIG. 3A shows allowable charging levels for a device during a charging interval;

FIG. 3B shows allowable charging levels for another device during a charging interval;

FIG. 4A shows price levels during a charging interval:

FIG. 4B shows variation in expected demand over a charging interval;

FIG. 5 illustrates a system architecture for implementing a further embodiment;

FIG. 6A illustrates the charge state of a client device over a charging interval in a first example;

FIG. 6B illustrates the charge state of a client device over a charging interval in a second example; and

FIG. 7 illustrates the relationship between parties involved in the operation of the embodiments.

### DETAILED DESCRIPTION

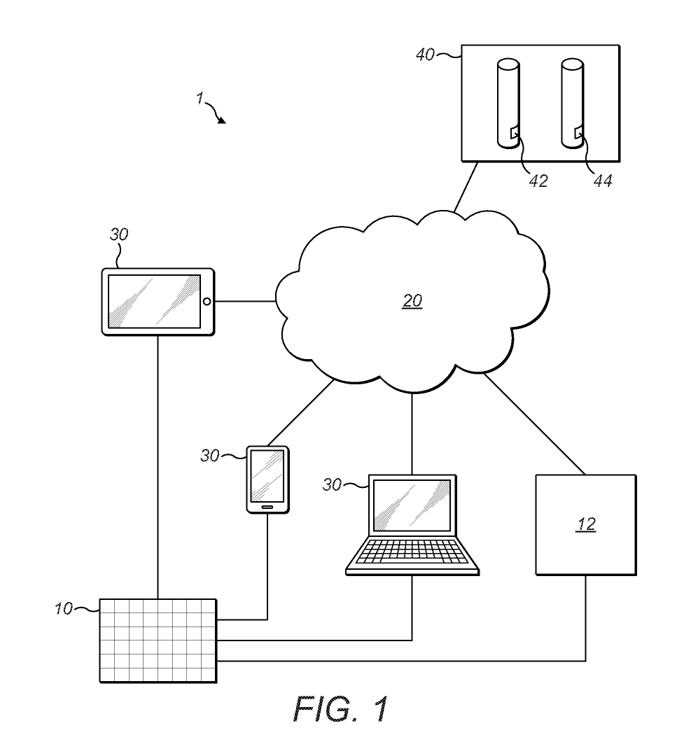

FIG. 1 illustrates a demand management system 1 in accordance with some embodiments. The system comprises a power network 10 and a communications network 20. The power network 10 is in this case an electricity grid, such as the National Grid operated in the United Kingdom. In some embodiments, the communications network 20 is the internet. In general, the communications network 20 is any network that enables communication between connected entities. Although the communications network 20 is implemented separately to the power network 10 in FIG. 1, the power network 10 and the communications network 20 may be implemented using a common architecture such that they share a common physical manifestation.

A plurality of client devices 30 are coupled to the power network 10 and the communications network 20. The client devices 30 are not limited by form factor and may have various capabilities. However, in general the client devices 30 comprise a local energy storage device, which may be internally housed or externally provided via a wired or wireless connection. The energy storage device may be a battery. In many examples, the client devices 10 are portable, but this is not essential. Client devices 30 that may be used in accordance with the present disclosure include personal computers (PCs), mobile phones, games consoles, tablet devices and intemet-enabled televisions. However, the client devices 30 are not limited to device types that are conventionally network enabled and/or battery powered, but may also include such household items as fridges, freezers, or washing machines for example. Indeed, client devices 30 are not limited to the domestic setting, but may find a range of uses in industrial, commercial or other circumstances. Client devices 30 may have local energy storage as a means to offering other functionality or may have a primary purpose of providing energy storage to other devices whether immediately co-located or further afield. In many examples, the client devices will include a user interface for receiving user inputs. The user interface may take the form of a keyboard, remote control, pointing device, touchscreen or any other interface as appropriate. Furthermore, the client devices 30 typically comprise a display which can be used to display images to the user.

The client devices 30 comprise network interfaces which allow them to communicate with other entities across the communications network 20. They also comprise power inputs for connection to the power network 10. The client devices 30 are designed to charge and and/or recharge their internal energy storage device from power received from the power network 10. The power network 10 may be a source of mains power provided by an electricity grid such as, for example, the National Grid in the UK.

Optionally, the client devices 30 also operate an application programming interface (API) which allows interrogation and control of power management features, such as charging/recharging. The API may be the Advanced Configuration and Power Interface (ACPI) developed as a known open standard for device configuration and power management by the operating system. ACPI is increasingly common across client devices and provides an interface which allows access to power management features from operating system level applications and in particular offer an interface that is accessible across the communications network 20.

The system also comprises a power network management server 12. The power network management server 12 may control various aspects of the power network 10. For example, the power network management server 12 may be adapted to vary the supply of power within the power network 10 by varying the operation of power sources such as power plants. Moreover, the power network management server 12 may be arranged to provide status information regarding the power network across the communications network 20.

The system further comprises a demand management server 40. The demand management server 40 comprises a network interface allowing it to communicate with other entities across the communications network 20. In particular, the demand management server 40 is communicatively coupled to the client devices 30 and the power network management server 12. The demand management server 40 and the power management server 12 may both be implemented using any appropriate means, including, but not limited to, a conventional computer server or a distributed cloud server. As such, the servers may be implemented on a single piece of hardware or across multiple hardware devices.

The demand management server 40 comprises a participating device (PD) database 42 and a grid data (GD) database 44. The PD database 42 stores information regarding the status of the client devices 30. This information may include information including, but not limited to: maximum charge capacity; possible charging rate; current charge level; whether the device is connected; current consumption rate; possible increased consumption states; possible decreased consumption states; previous period actual consumption; current physical location; and user preferences—including charge times, load states, when batteries are required to be full etc. Of this listed information, all except the current location and the user preferences may be obtained via the ACPI. Location information may be obtained via known methods such as the Global Positioning System (GPS), or using General Packet Radio Service (GPRS) or IP address information in a manner known in the art. User preferences are typically set by users of the client devices, either through the client device or on another network-enabled device. However, some user preferences may take a value set elsewhere, for example a default value if a user has not yet established their preferences or an automatically generated value based on some other criteria. The status information stored by the PD database also comprises charging intervals for each client device 30. The charging interval represents a time during which a client device 30 is expected to be available for charging. Some devices are portable, and expected to be removed from connection to the power network, in which case the charging interval may be associated with the time during which the device is expected to be connected. Other devices may be permanently or semi-permanently connected to the network, in which case the charging interval is not defined by a point at which disconnection is expected, but may be selected for other considerations. The charging interval represents a time during which control of the charging of the device will be carried out by the system. For permanently connected devices, when one charging interval ends a new one may start. This may be set by user preferences or may be known from elsewhere.

The GD database comprises information obtained from the power network management server 12. This may include information regarding the current supply to the power network 10 and information regarding the current demand in the power network 10. It may also include predictions for demand and/or supply during an upcoming period of time. For example, it may contain information reflecting an expected reduction in demand overnight, or indeed an expected drop in supply from solar sources during the same period. Information stored on the GD database 44 may comprise a geographical element, such that, for example, an increase in demand in a particular location is recognised.

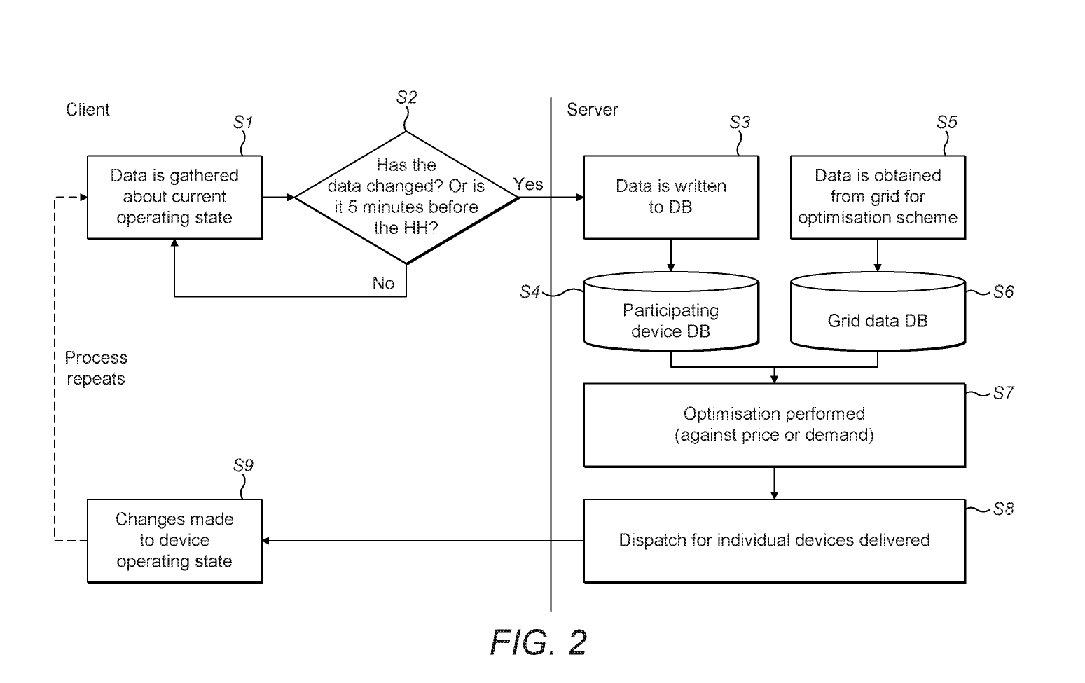

Operation of the embodiment shown in FIG. 1 can be understood with reference to FIG. 2, which shows a flow diagram for a method for controlling demand in the system. FIG. 2 is divided into a left hand side which illustrates steps taken at the client device 30, and a right hand side which illustrates steps taken at the demand management server 40.

At step s1, data is gathered regarding the current operating state (i.e. status information) of each client device 30. As mentioned above, this information may be gathered using the ACPI at the client device 30, as well as through other means such as any GPRS system at the device 30. The client device 30 is configured to report status information to the demand management server 40 at regular intervals or each time a change in the status information is identified. In the example shown in FIG. 2, demand management is implemented for successive half hour charging periods, and the status information is returned to the demand management server 40 at a predefined time, for example 5 minutes before each half hour period begins.

Accordingly, at step s2, an assessment of whether the status information has changed or whether it is now, for example, five minutes before the next half hourly period is made. If the answer to both these questions is no then the client device 30 continues to monitor the status information and takes no further action. If the answer to either question is yes then the status information is transmitted to the demand management server 40. Other schedules for providing the status information are equally possible.

At step s3, the demand management server 40 writes the status information received from the client devices 30 into the PD database 42. Although FIG. 2 only illustrates the actions of a single client device 30 it will be understood that all participating client devices 30 carry out the same process and so the demand management server 40 receives data from multiple client devices 30. At step s4, the status information received from the client device 40 is maintained (i.e. the data is persistently stored) in the PD database 42.

Concurrently with, or prior or subsequent to, the receipt of status information from the client devices 30, the demand management server 40 obtains network status information from the power network management server 12 at step s5. Again, this data is obtained across the communications network 20. It is stored in the GD database 44 at step s6.

At step s7, a charging scheme is developed for the client devices 30 over the subsequent charging period or periods within the charging interval established for that client device 30. In particular, the charging scheme computes the optimal allocations of demand between the client devices 30 for the coming periods, in accordance with some optimisation criteria, for example minimising cost to the user during the charging interval. The charging scheme is calculated using the status information in the PD database 42 and grid information in the GD database 44. In particular, the charging scheme for a given client device 30 may depend on status information relating to other client devices 30, meaning that the charging schemes for each client device 30 are not developed in isolation, although calculation separately for each client device 30 based on respective separate instances of status information may be used in some embodiments. For example, demand from a given client device 30 may be deferred until a later period if it is determined that it will still have access to power at that later period and that to provide that client device with power during the current period would increase an imbalance between supply and demand in the power network 10. Another client device 30 may be provided with power sooner if it is determined that that device is in greater need or will not be available later.

Given the stored information in the databases 42, 44, the charging scheme may take account of the requirements of the individual client devices 30 and of the power network 10. In particular, information regarding the location of the client devices 30 can be used to ensure an even load geographically across the power network 10. Furthermore, the urgency of power for each client device 30 can be assessed given knowledge of power usage for that device and the current state of it internal power storage (for example, it can be established how long a client device will be able to operate from battery power or any other local storage).

While it is inefficient and expensive to provide centralised large scale electrical storage for energy, the described embodiment effectively takes advantage of the aggregate distributed storage capabilities of the client devices 30 in order to smooth the demand profile and/or adjust the demand profile towards current supply within the power network 10. This can ensure a more efficient usage of resources within the system 1.

The charging scheme represents an optimal path of instantaneous demand amongst the client devices 30 for a subsequent charging period. For example, if there is presently a relatively high demand in the power network relative to supply, then the charging scheme may act to reduce that demand, but only in the knowledge that at a later point in the charging period there is likely to be either an increased supply or reduced demand from elsewhere. Thus, using information in both the PD database 42 and the GD database 44, optionally a forecast of demand is established in order to assist in the development of the charging scheme. For example, once an understanding of the likely relationship between supply and demand is established during the charging interval, calculations can be made working backwards from a desired result at the end of the charging period to find the most optimal allocation of demand amongst the client devices 30 given future expectations. The charging interval may be any appropriate length of time and can be established, for example, by user preferences for the client device.

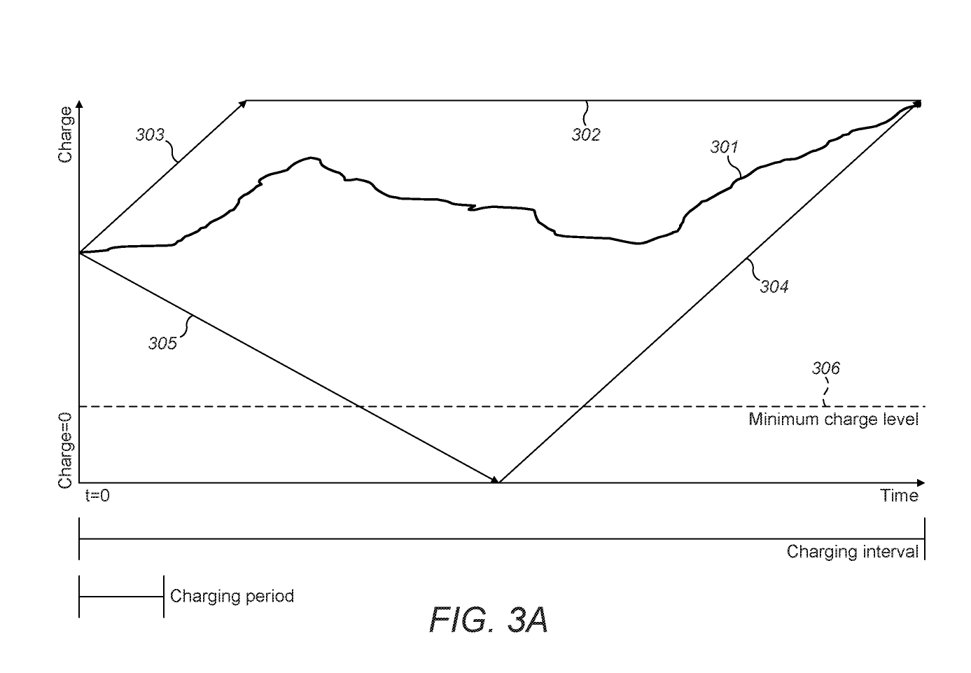

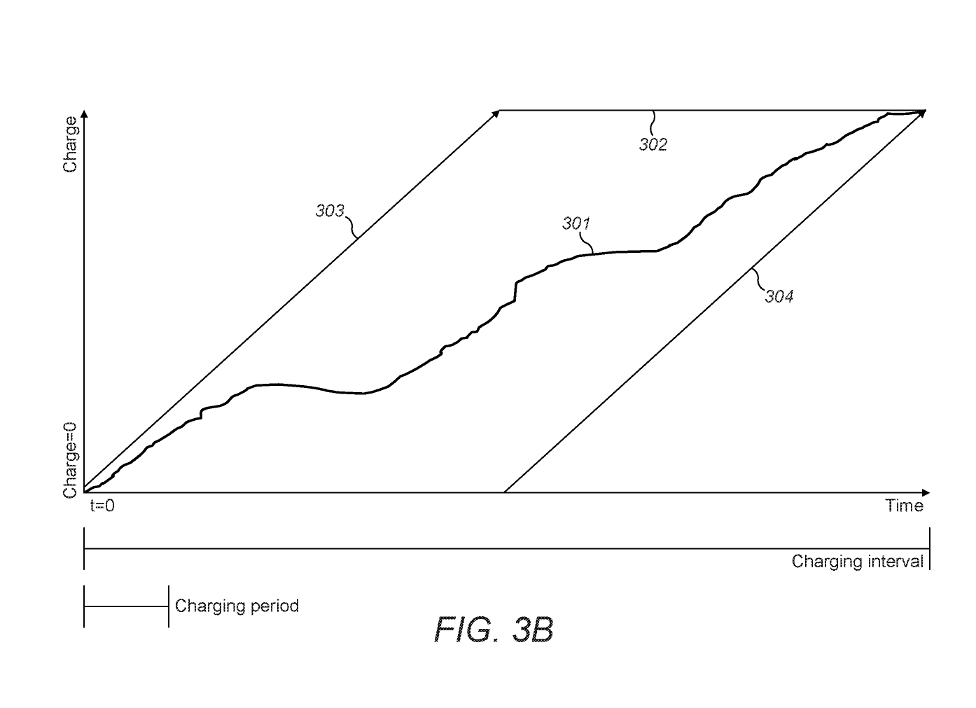

FIG. 3A illustrates the management of the charging of a device across a charging interval. The charge level of the device when charged according to the charging scheme, is shown as line 301. In this case, the desired outcome at the end of the charging period is that the device has maximum charge, while initially the device was provided with a non-zero level of charge.

Lines 303 and 304 represent the maximum rate of charge for the device. For example, line 303 the response of the device if it were charged at the maximum rate from the start of the charging interval. On the other hand, line 304 shows the latest point at which maximum charging will leave the device fully charged at the end of the time interval.

Line 302 represents the maximum charge level of the device, while line 305 represents the rate at which the device would lose charge from its initial state if no action were taken. Accordingly, lines 302, 303, 304, and 305 together bound the potential charge states during the charging interval if it is to meet the requirement of being fully charged at the end of the interval. As can be seen, from line 301, this allows a degree of freedom to the actual charge state over the interval. This means that the charging scheme can be optimised to cause the device to charge at preferred times.

In addition to the above requirements, a minimum charging state 306 is shown. User preferences can state that at no time should the device charge level drop below this value. In this way, the minimum charging state 306 also provides a boundary to the available charge

FIG. 3B shows another example plot giving the possible path (line 301) of the charge state of a charging device during a charging interval. In this case, the device starts at a zero charge level and is required to reach a maximum charge level within the charging interval. The maximum charging rate is again illustrated by lines 303 and 304, while the maximum charging level is shown by line 302. Within the boundaries set by lines 302, 303, 304 a charging scheme can be developed for the path 301 of the charging state of the device.

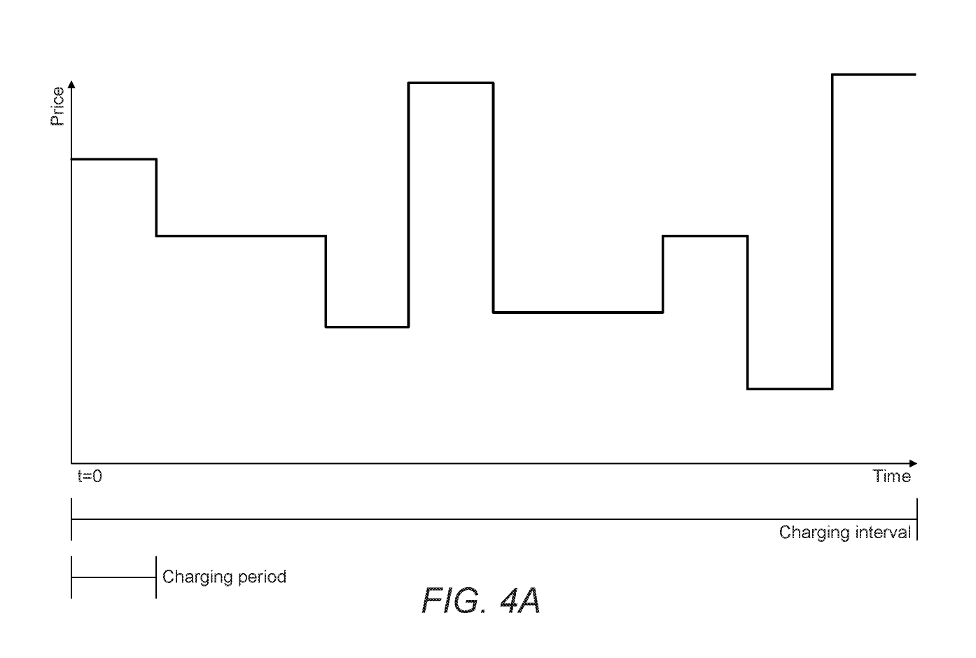

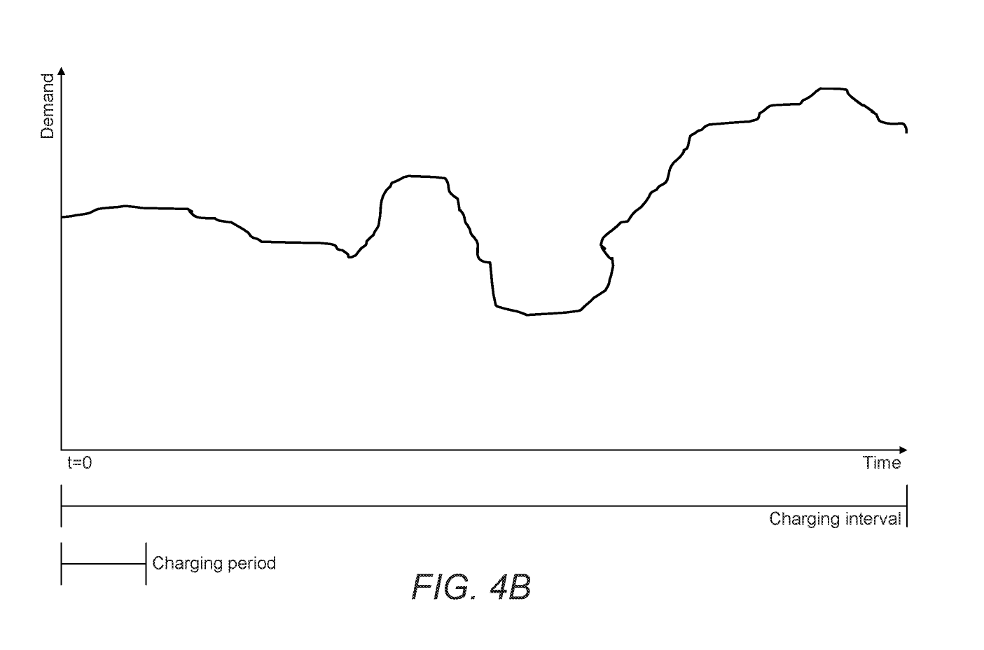

FIGS. 3A and 3B show a charging period in comparison with the charging interval. Typically, a charging interval will comprise a plurality of sequential charging periods. These charging periods may correspond to the periods at the end of which the charging scheme for each device is updated. These charging periods may correspond to price periods provided by the power network. In particular, power networks often fix prices for a given price period. This is illustrated in FIG. 4A. Here, the price of power within the power network is shown for a charging interval. The price is held at a given value during each charging period.

The charging scheme can be arranged to be responsive to scheduled pricing plans such as that shown in FIG. 4A. For example, the charging scheme may be arranged to minimise the cost of charging during the charging interval. In this way, the charging process can be managed to charge a device at a relatively inexpensive time while remaining within the available boundaries as shown in FIGS. 3A and 3B, for example. The pricing plan shown in FIG. 4A is an example of grid information.

FIG. 4B shows a predicted demand curve across a forthcoming charging interval. In this case, the expected demand is not related to the charging periods but instead varies continuously. This grid information may also be used to optimise the charging scheme. For example, efforts can be made to minimise variation in demand.

Further grid information can additionally or alternatively be used when developing an appropriate charging scheme. For example, there may be a user preference set for particular energy sources (such as renewable sources) and the charging scheme may attempt to maximise the amount of such sources that are used. In another example, a user may set a maximum price they are willing to pay, accepting that the device will not be charged if the price does not fall as requested. The charging scheme can be arranged to minimise factors, such as cost or carbon usage, or may be arranged to maximise other factors of interest (use of renewable sources, for instance). Moreover, multiple factors may be balanced in the selection of the charging scheme.

Once the charging scheme has been developed then appropriate instructions can be transmitted across the communications network 20 to each client device 30 at step s8 (as shown in FIG. 2). Each client device 30 receives instructions and applies them at step s9. For example, instructions can be applied using the ACPI to change the charging state of the client device 30. Specifically the “force_charge” and “inhibit_charge” attributes may be used to control the client device 30 via a System Management Bus (SMBus) in order to cause the client device 30 to charge from the power network 10 or operate from its internal storage respectively.

At regular intervals, for example at the end of each charging period, the client device 30 may report back to the demand management server 40 on the actual amount of energy drawn during that time. The charging period may be half an hour. This will assist the demand management server in assessing the requirements of the client devices 30 and recording aggregate demand to demonstrate improvements due to the system and for billing purposes.

The charging scheme may be updated periodically, such as at the end of each charging period. For example, there may be a change in the predicted price reflected in FIG. 4A, and the charging scheme may be updated to take account of this. Furthermore, a change in user preferences might be detected or a change in some other aspect of status or grid information. An updated charging scheme can then be run for the remainder of the charging interval. While updates may take place periodically, the may also take place in real time, ensuring that the charging scheme reflected changes as soon as they occur. Some embodiments include a trigger to force immediate updates when certain conditions, such as low availability of supply are detected.

The predicted price of FIG. 4A is a predicted energy cost. Predicted energy costs can be established in any appropriate manner. For example, the predicted energy costs can be understood through prices established in the forward markets, such as “Within Day” and “Day Ahead” markets, or through agreed fixed prices for future purchases. As these prices may be set in advance, they can be predicted with a high degree of certainty. More intricate estimated costs may be achieved through forecasting forward electricity prices for each half-hour (or other) period in future, informed by a view of market conditions such as current spot price, history and expected upcoming events. These predictions may be less certain than prices fixed by the markets, but may provide a greater degree of granularity in terms of time frame.

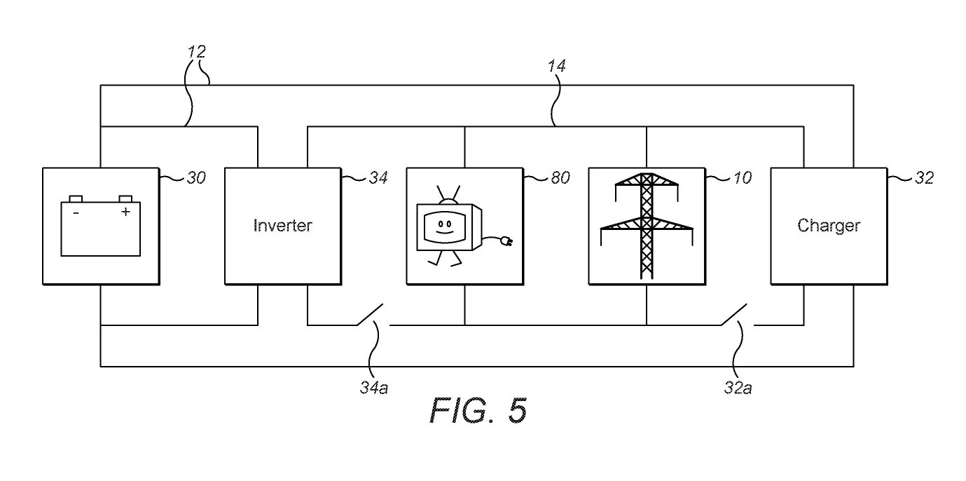

FIG. 5 shows a further embodiment. In this embodiment, the client device 30 is a local storage device designed to provide power to domestic or commercial premises. The client device 30 can be used to store power from the power network 10 at times when electricity is relatively cheap, and provide power to local appliances and devices 80 when power is relatively expensive.

The client device 30 may be located, for example, in a customer's home. Alternatively, a single client device 30 may provide support to a number of separate premises and may be located at a separate facility. FIG. 5 illustrates an AC network 14 to which the power network 10 and the appliances/devices 80 are connected and a DC network 12 to which the client device 30 is connected.

Power can be transferred from the AC network 14 to the DC network 12 in order to charge the client device 30 via a charger 32. A switch 32a is provided to selectively manage this transfer. When an instruction to charge the client device 30 is received, switch 32a is closed and the charger 32 applies power to the client device 30.

Power can be transferred from the DC network 12 to the AC network 12 in order to discharge the client device 30 via an inverter 34. A switch 34a is provided to selectively manage this transfer. When an instruction to charge the client device 30 is received, switch 34a is closed and the inverter 34 applies power from the client device 30 to the local appliances/devices 80.

Accordingly, the client device 30 can be selectively used to apply power to the local appliances/devices 80. During a charging interval, there will be periods in which the cost of electricity is high and periods during which it is low. By charging the client device 30 during the low cost periods and discharging it during the high cost periods, the overall cost to utilise the same amount of power can be reduced.

In order to calculate an appropriate charging scheme over the charging interval, it is desirable to know both the predicted cost of energy during charging periods within the charging interval and the expected discharge rate of the client device 30. The discharge rate indicates the rate at which the client device 30 is discharged when switch 34b is closed. It is possible that the expected discharge rate of the client device 30 will vary over the charging interval according to the expected usage of the local appliances/devices 80.

The client device 30 of the embodiment shown in FIG. 5 may be in permanent operation. Nevertheless, a charging scheme is developed for a finite time period—i.e. a charging interval. The charging intervals may follow consecutively without any gaps in order that the client device 30 is permanently under suitable control.

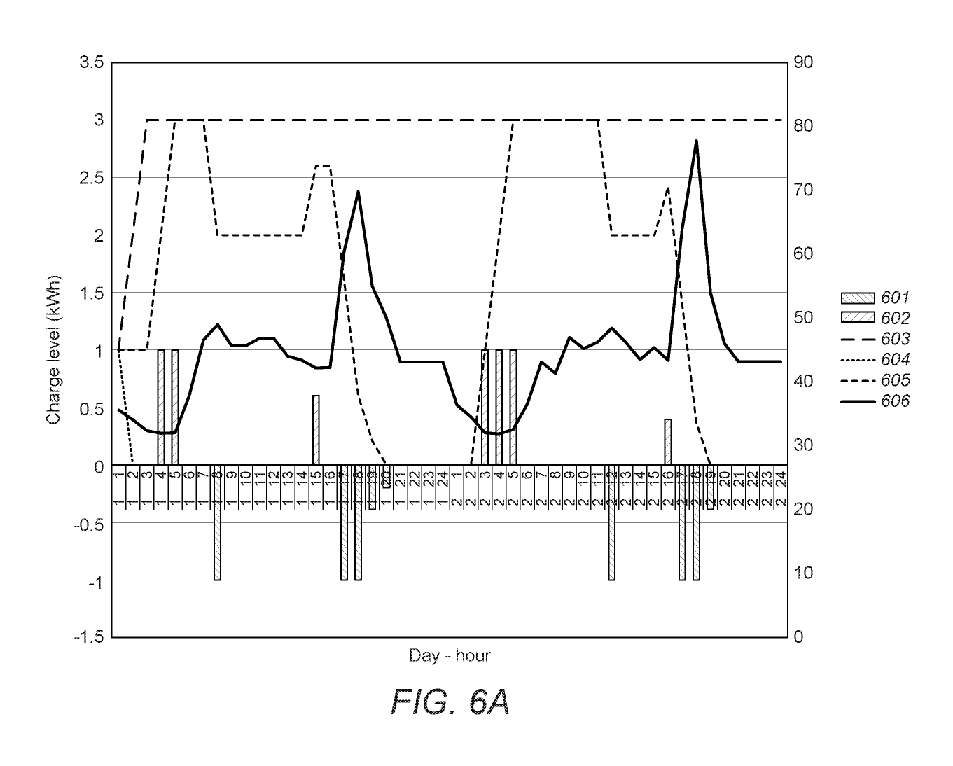

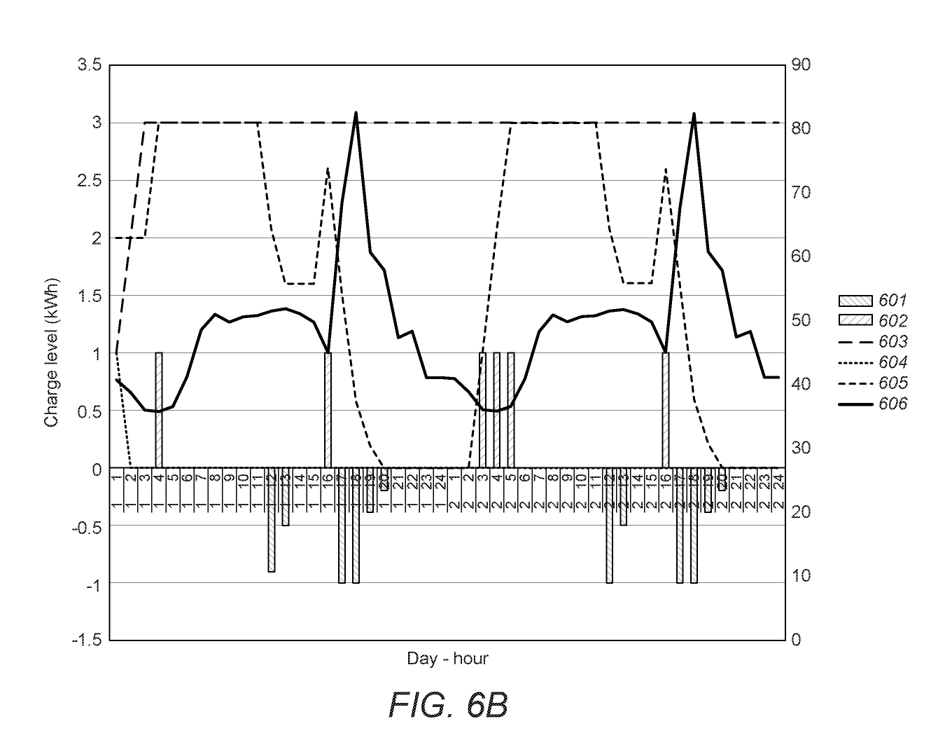

FIG. 6A illustrates the exemplary behaviour of a client device 30 according to the embodiment shown in FIG. 5 across a 48 hour (two day) charging interval. It will be understood that charging intervals of differing lengths may also be used, and that these may affect the charging scheme developed for the client device 30.

In the example shown in FIG. 6A, the charging scheme is designed to maintain the charge state of the client device 30 between an upper bound 603 and a lower bound 604. In this example, the charge state 605 of the client device stats at a level of 1 kWh, while maximum charge is 3 kWh. The lower bound 604 is zero for the majority of the interval, meaning that the charge state of the client device 30 is allowed to drop to this level. A higher lower bound 604 could be implemented if it was desired that the client device always maintain some charge.

The line 605 illustrating charge state over the interval shows the progression of the charge state as the client device 30 is charged and discharged. Charging occurs at injection points 602, while discharging occurs at withdrawal points 601. The charging scheme defines the position and magnitude of the injection points 602 to define when the client device 30 charges. The charging scheme may also define the position and magnitude of the withdrawal points 601 in order to define when the client device 30 is used as a power source, for example to power local devices/appliances 80.

The charging scheme depends upon the known discharge rate or rates that occur when the client device 30 is used as a power source. The charging scheme also depends upon the market price 606 for electricity defined for periods within the charging interval. In this manner, the charging scheme develops optimal points to inject and withdraw charge from the client device 30 while remaining within the range defined by upper bound 603 and lower bound 604. The optimisation may be carried out to reduce the overall cost of energy consumed from the power network 10 during the charging interval.

It will be understood that FIG. 6A is an example of the potential development of charge state 605 over an interval of 48 hours following an optimum charging scheme. The appropriate charging scheme, and thus the development of the charge state 605, will depend on particular circumstances. For example, a different initial charge level will modify the required charging during the interval and will thus modify the progression for the charge state 605, as will a different predicted energy cost. This is illustrated in FIG. 6B, which shows the same details as FIG. 6A but with a starting charge level of 2 kWh a different profile for predicted energy costs 606. Comparison of FIG. 6B with FIG. 6A demonstrates the effects that such changes may have, both on the charging scheme and the consequent development of the charge state 605.

I will also be recognised that the choice of a different charging interval will modify behaviour. For example, a shorter charging interval will not take account of predicted price increases after the interval finishes.

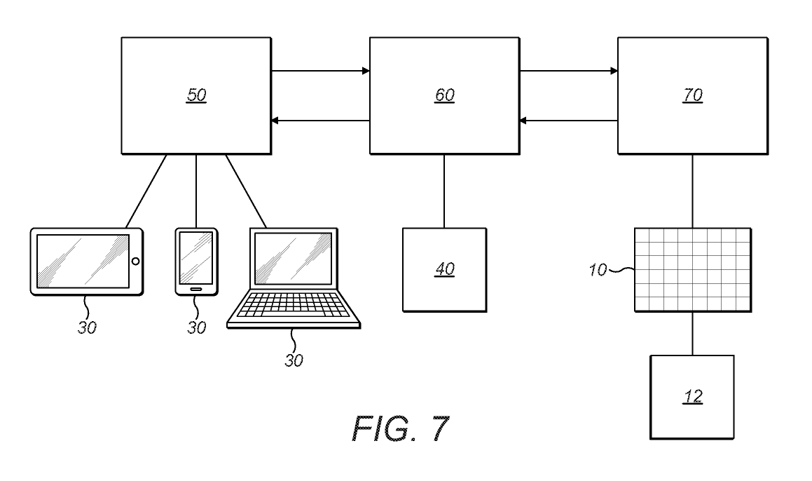

In some embodiments, the systems described above can be implemented under the control of the entities illustrated in FIG. 7. Firstly, a plurality of users 50 are responsible for one or more client devices 30 each. A demand management service 60 operates the demand management server 40 and a power provider 70 operates the power network 10 and power network management server 12.

The demand management service aggregates demand control of users' 50 client devices 30. In return payment is provided to the users. This payment may be a regular fixed value, but is likely to be dependent upon the number and nature of the client devices 30 that each user 50 allows the demand management service 60 to control. It may also be a function of the amount of time the user allows this control to be exercised for.

Payments to the users may be predictable or may be based on a lottery or raffle system for example. That is to say, users 50 may be provided with entry to a lottery in return for allowing control of charging of their client devices 30 to pass to the demand management service 60. Payment is made when a user wins this lottery. This allows larger individual payments to be made to users 50.

Having aggregated the control of the client devices 30, the demand management service manages the charging of the client devices from the power network at the demand management server. The demand management service 60 may then obtain data regarding power usage by client devices from the power network and provide that data to the power supplier 70. The power supplier 70 may provide payment in return for this demonstrable improvement in demand management, thus allowing the demand management service 60 to generate a revenue system that assists in the payments to be passed to the users 50. The power provider 70 may, or example, be the national grid or an energy company. The power provider 70 benefits from the managed demand offered by the demand management service 60.

Other variations and modifications will be apparent to the skilled person. Such variations and modifications may involve equivalent and other features which are already known and which may be used instead of, or in addition to, features described herein. Features that are described in the context of separate embodiments may be provided in combination in a single embodiment. Conversely, features which are described in the context of a single embodiment may also be provided separately or in any suitable sub-combination. It should be noted that the term “comprising” does not exclude other elements or steps, the term “a” or “an” does not exclude a plurality, a single feature may fulfill the functions of several features recited in the claims and reference signs in the claims shall not be construed as limiting the scope of the claims. It should also be noted that the Figures are not necessarily to scale; emphasis instead generally being placed upon illustrating the principles of the present disclosure.

1. A method for managing demand within a power network, comprising
obtaining status information regarding a plurality of client devices, the status information including information defining for each client device a charging interval and information defining a discharge rate for each client device during the charging interval;
obtaining grid information regarding a power network, the grid information defining predicted energy costs for a plurality of charging periods within the charging interval;
deriving, based on the status information and the grid information, a charging scheme for each client device to be applied during the charging interval, wherein the charging scheme comprises instructions regarding times during the charging interval the client device should and should not charge; and
transmitting instructions to the client devices in accordance with the charging scheme during the charging interval.

2. A method according to claim 1, wherein the status information comprises location information for the client device, and wherein the charging scheme is determined in dependence upon the location information.

3. A method according to claim 1, wherein the charging scheme is effective to defer charging of at least one of the client devices.

4. A method according to claim 1, wherein the charging scheme further comprises instructions regarding times during the charging interval the client device should and should not discharge

5. A method according to claim 1, wherein the charging scheme is calculated to minimise cost incurred during the charging interval.

6. A method according to claim 1, wherein the grid information comprises predicted energy cost in the power network during the charging interval.

7. A method according to claim 1, further comprising periodically updating the charging scheme.

8. A method according to claim 1, further comprising receiving usage information from at least one of the client devices regarding power used by each of the at least one of the client devices during the respective charging interval.

9. A method for controlling charging of a device, comprising
transmitting status information to a demand management server, the status information including information defining a charging interval;
receiving instructions from the demand management server reflecting a charging scheme to be applied during the charging interval; and
charging the device in accordance with the received instructions during the charging interval.

10. A method for managing demand within a power network, comprising
aggregating charging control of a plurality of client devices associated with a plurality of users;
managing charging of the plurality of client devices from a power network at a demand management server;
obtaining data regarding power usage by client devices from the power network; and
providing data regarding power usage to a power provider associated with the power network.

11. A computer program product comprising computer executable instructions for carrying out the method of claim 1.

12. A system for managing demand, comprising
a power network;
a communications network;
a plurality of client devices connected to both the power network and the communications network; and
a demand management server for receiving status information regarding the client devices and grid information regarding the power network, the status information including information defining for each client device a charging interval and information defining a discharge rate for each client device during the charging interval and the grid information defining predicted energy costs for a plurality of charging periods within the charging interval, wherein
the demand management server is arranged to determine a charging scheme for each client device to be applied during the charging interval using the status information and the grid information wherein the charging scheme comprises instructions regarding times during the charging interval the client device should and should not charge, and the demand management server is arranged to transmit instructions to the client device in accordance with the charging scheme during the charging interval.

13. A system according to claim 12, wherein the status information comprises location information for the client device, and wherein the charging scheme is determined in dependence upon the location information.

14. A system according to claim 12, wherein the charging scheme is effective to defer charging of at least one of the client devices.

15. A system according to claim 12, wherein the charging scheme comprises instructions regarding times during the charging interval the client device should and should not discharge.

16. A system according to claim 12, wherein the charging scheme is calculated to minimise cost incurred during the charging interval.

17. A system according to claim 12, wherein the grid information comprises predicted energy cost in the power network during the charging period.

18. A system according to claim 12, wherein the demand management server is configured to periodically update the charging scheme.

19. A system according to claim 12, wherein the demand management server is configured to receive usage information from at least one of the client devices regarding power used by each of the at least one of the client devices during the respective charging period.

20. A client device comprising a processor configured to:
transmit status information to a demand management server, the status information including information defining a charging interval;
receive instructions from the demand management server reflecting a charging scheme to be applied during the charging interval; and
cause charging of the device in accordance with the received instructions.
